(19) United States
(12) Patent Application Publication
(10) Pub. No.: US 2021/0140578 A1
(43) Pub. Date: May 13, 2021

(54) SEWER HOSE COVER

(71) Applicant: Mallorie Rasberry, Laurel, MS (US)

(72) Inventor: Mallorie Rasberry, Laurel, MS (US)

(21) Appl. No.: 16/679,485

(22) Filed: Nov. 11, 2019

(51) Int. Cl. F16L 55/00

(52) U.S. Cl. CPC F16L 55/00; F16L 2201/80

(57) ABSTRACT

A sewer hose cover is made out of an elongated fabric sheet having a front edge, a rear edge, a first side edge, and a second side edge. The first side edge and the second side edge run along a length of the elongated fabric sheet. A first set of weights are coupled to the elongated fabric sheet along the first side edge. A second set of weights are coupled to the elongated fabric sheet along the second side edge.

### BACKGROUND OF THE INVENTION

The present invention relates to recreational vehicle sewer hoses and, more particularly, to a sewer hose cover for covering sewer hoses.

Recreation vehicles (RV) have on board bathrooms. The toilets lead to wastewater tanks, which are then emptied into a dump station. The dump station usually includes a small concrete pad with a 3 to 4-inch brass fitting embedded into the concrete. The fitting accepts a sewer hose from the RV. Sewage dumped into the station goes into a sewer or a septic system. Sewer hoses are exposed during this process and are generally unsightly.

As can be seen, there is a need for a sewer hose cover for covering sewer hoses.

### SUMMARY OF THE INVENTION

In one aspect of the present invention, a sewer hose cover comprises: an elongated fabric sheet comprising a front edge, a rear edge, a first side edge, and a second side edge, wherein the first side edge and the second side edge run along a length of the elongated fabric sheet; a first set of weights coupled to the elongated fabric sheet along the first side edge; and a second set of weights coupled to the elongated fabric sheet along the second side edge.

In another aspect of the present invention, a method of covering a sewer hose comprises steps of: providing a sewer hose cover comprising: an elongated fabric sheet comprising a front edge, a rear edge, a first side edge, and a second side edge, wherein the first side edge and the second side edge run along a length of the elongated fabric sheet; a first set of weights coupled to the elongated fabric sheet along the first side edge; and a second set of weights coupled to the elongated fabric sheet along the second side edge; draping the elongated fabric sheet over the sewer hose so that the first set of weights are resting on a surface on a first side of the sewer hose and the second set of weights are resting on the surface on a second side of the sewer hose.

These and other features, aspects and advantages of the present invention will become better understood with reference to the following drawings, description and claims.

### BRIEF DESCRIPTION OF THE DRAWINGS

FIG. 1 is a top perspective view of an embodiment of the present invention;

FIG. 2 is a bottom perspective view of an embodiment of the present invention;

FIG. 3 is a side view of an embodiment of the present invention;

FIG. 4 is a side view of an embodiment of the present invention;

FIG. 5 is a side view of an embodiment of the present invention shown in use; and

FIG. 6 is a perspective view of an embodiment of the present invention show in use.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a sewer hose cover that covers the sewer hose of an RV, making the overall RV appearance more attractive, stylish and cleaner. The fabric is designed to drape over an existing RV sewer hose and cover it. The closure at one end is designed to fit snugly around the sewer hookup. The weights and fasteners are designed to keep the skirt in place.

Referring to FIGS. 1 through 6, the present invention includes a sewer hose cover 10. The sewer hose cover 10 may be made out of an elongated fabric sheet 13 having a front edge, a rear edge, a first side edge, and a second side edge. The first side edge and the second side edge run along a length of the elongated fabric sheet 13. A first set of weights 15 are coupled to the elongated fabric sheet 13 along the first side edge. A second set of weights 15 are coupled to the elongated fabric sheet 13 along the second side edge.

As illustrated in FIG. 3, the elongated fabric sheet 13 may include a rectangular shape. As illustrated in FIG. 4, the elongated fabric sheet 16 may include an elongated trapezoid shape, tapering from the rear edge to the front edge. The tapered edges account for an end of the hose 15 being elevated at the RV 17 relative to the remainder of the hose 15.

The elongated fabric sheet 13 may be made of an outdoor fabric, such as nylon, polypropylene, ripstop and the like. The elongated fabric 13 may include dimensions that match the sewer hose 14. For example, the elongated fabric 13 may include a width of about 28 inches and a length of about 10 ft to about 20 ft, such as about 15 ft. A seam may be sewn at the front edge to fit snug around the ground sewer hook-up. The weights 15 are sewn to the sides and a fastener is sewn at the end of the elongated fabric 13.

The present invention may further include a plurality of handles 14 coupled to an upper surface of the elongated fabric sheet 13 along the length. The plurality of handles 14 are centrally disposed in between the first side edge and the second side edge. The plurality of handles 14 may each include a looped strap stitched to the upper surface of the elongated fabric.

After the sewer hose 18 from an RV 17 has been traditionally hooked-up, the user may follow the below method steps. A method of covering a sewer hose 18 may include the following: provide the sewer hose cover 10 described above; and drape the elongated fabric sheet 13 over the sewer hose 18 so that the first set of weights 15 are resting on a surface on a first side of the sewer hose 18 and the second set of weights 15 are resting on the surface on a second side of the sewer hose 18. The end with a seam fits tightly around the sewer ground hook up. The elongated fabric sheet 13 may be flexible to maneuver around the sewer hose and fit to its shape. The sewer hose cover 10 could also be used to cover unsightly utility pipes, cords, sewer lines, etc.

It should be understood, of course, that the foregoing relates to exemplary embodiments of the invention and that modifications may be made without departing from the spirit and scope of the invention as set forth in the following claims.

What is claimed is:

1. A sewer hose cover comprising:
an elongated fabric sheet comprising a front edge, a rear edge, a first side edge, and a second side edge, wherein the first side edge and the second side edge run along a length of the elongated fabric sheet;
a first set of weights coupled to the elongated fabric sheet along the first side edge; and
a second set of weights coupled to the elongated fabric sheet along the second side edge.

2. The sewer hose cover of claim 1, wherein the elongated fabric sheet comprises a rectangular shape.

3. The sewer hose cover of claim 1, wherein the elongated fabric sheet comprises an elongated trapezoid shape.

4. The sewer hose cover of claim 1, further comprising a plurality of handles coupled to an upper surface of the elongated fabric sheet along the length, wherein the plurality of handles are centrally disposed in between the first side edge and the second side edge.

5. The sewer hose cover of claim 4, wherein the plurality of handles each comprise a looped strap stitched to the upper surface of the elongated fabric sheet.

6. A method of covering a sewer hose comprising steps of:
providing a sewer hose cover comprising:
an elongated fabric sheet comprising a front edge, a rear edge, a first side edge, and a second side edge, wherein the first side edge and the second side edge run along a length of the elongated fabric sheet;
a first set of weights coupled to the elongated fabric sheet along the first side edge; and
a second set of weights coupled to the elongated fabric sheet along the second side edge;
draping the elongated fabric sheet over the sewer hose so that the first set of weights are resting on a surface on a first side of the sewer hose and the second set of weights are resting on the surface on a second side of the sewer hose.

7. The method of claim 6, wherein the elongated fabric sheet comprises a rectangular shape.

8. The method of claim 6, wherein the elongated fabric sheet comprises an elongated trapezoid shape.

9. The method of claim 6, wherein the sewer hose cover further comprises a plurality of handles coupled to an upper surface of the elongated fabric sheet along the length, wherein the plurality of handles are centrally disposed in between the first side edge and the second side edge.

10. The method of claim 9, wherein the plurality of handles each comprise a looped strap stitched to the upper surface of the elongated fabric sheet.
